(19) United States
(12) Patent Application Publication
(10) Pub. No.: US 2005/0044984 A1
(43) Pub. Date: Mar. 3, 2005

(54) Reinforced tension and compression reacting strut and method of making same

(76) Inventor: Brian H. Jones, San Gabriel, CA (US)

Correspondence Address: ROBERT J. SCHAAP, Suite 188, 21241 Ventura Boulevard, Woodland Hills, CA, 91364, US

(21) Appl. No.: 10/650,441

(22) Filed: Aug. 27, 2003

(51) Int. Cl. G05G 1/00

(52) U.S. Cl. 74/579 R

(57) ABSTRACT

A reinforced composite strut capable of reacting both compression and tension loads. The strut is preferably comprised of a fiber reinforced composite elongate body with fittings, such as metal fittings, secured to the ends thereof. The fittings may be secured by means of an adhesive and are reinforced by means of a filament band wound about the fittings and the elongate body. The strap wound upon the body allows for reacting tension loads and the body reacts to compression loads. A method of making the strut is also disclosed.

### BACKGROUND OF THE INVENTION

1. Field of the Invention

This invention relates in general to certain new and useful improvements in load bearing struts and, more particularly, to load bearing struts which are capable of effectively and efficiently reacting to compressive loads and tension loads in the same strut.

2. Brief Description of Related Art

Although struts were made primarily of metals such as steel and even stainless steel, with the recognition that reinforced composites are effective and even more efficient substitutes, many struts are made of reinforced composite materials. While reinforced composites provide lighter weight and, in many cases, stronger reinforcement than that provided by the metal counterparts, they are limited in terms of reacting to a variety of force loads. Thus, and while a reinforced composite strut is effective in reacting to tension loads, it may not be effective in reacting to compressive loads and vice versa.

Struts are highly effective in load transfer since they are geometrically simple, structurally efficient and relatively easy to produce. When the struts are formed of composite materials, as aforesaid, significant weight savings, in the range of 40-60% over counterpart materials such as heavy metals, are attainable.

Struts made of reinforced plastic composite materials are widely used in a variety of applications including, for example, struts in automotive vehicles and, particularly, in aircraft. As a simple example, a strut may be effective in absorbing the load imposed on portions of an aircraft. In many cases, vehicles, including both aircraft and automotive vehicles, may employ shock absorber systems. These systems primarily absorb the shock of impact, but they do not effectively absorb the load imposed on a portion of the vehicle.

A strut can be designed to react to a compressive load or otherwise a tensional load, depending upon the fiber layer pattern, the number of layers, the types of fibers used and other factors. However, it is recognized that most struts are not effective in reacting to both tension loads and compression loads simultaneously. This is due to the nature of the fibrous material and, particularly, the fact that it does not react well to a multitude of loads, simultaneously. There have been attempts to provide strut-like structures as, for example, in tiebars and the like, for reacting to tensile loads and torsional loads. There has even been a filament containing tiebar, in the nature of a strut, in which the filament structure was encased by an elastomer as, for example, in U.S. Pat. No. 3,279,278, dated Oct. 18, 1966 to Eldred.

Struts are frequently subjected to both tension and compression loads, as aforesaid. In tension, the strut could fail along its length. However, since the load applied to the strut is not always pure tension, some shear loading could be imposed on the strut. Moreover, composite materials are not capable of reacting effectively in shear and can fail. In compression loads, the strut usually does not fail in shear but it can buckle. Therefore it is necessary to effectively provide a strut which can primarily handle tension and compression loading.

The problem of subjecting a reinforced composite structure to more than one type of load simultaneously is also discussed in U.S. Pat. No. 4,715,589, dated Dec. 29, 1987, to Woerndle. Woerndle points out certain load conditions in which a loop can be provided, but also in which the loop can break due to high radial compression loads. In this case, Woerndle points out how the matrix material is subject to the rupture.

It would be highly desirable to provide a strut which is capable of effectively reacting both tension loads and compression loads simultaneously without suffering from the deleterious effects of other loads imposed on the strut.

### OBJECTS OF THE INVENTION

It is, therefore, one of the primary objects of the present invention to provide a strut, formed of reinforced plastic composite material, and effective in reacting to both compressive and tension loads.

It is another object of the present invention to provide a strut of the type stated which relies upon the use of fittings at the end of an elongate composite member and with a tension reacting strap securing the fittings to the elongate member and causing the fittings to effectively become integral with the elongate member.

It is a further object of the present invention to provide a strut of the type stated, which is of relatively low weight but has strength characteristics equivalent to metal struts, and which can be made at a relatively low cost. The low cost factor is important such that a large number of these struts can be used in a variety of structures.

It is an additional object of the present invention to provide a method of making a reinforced plastic composite strut which is efficient in reacting to both compressive and tension loads.

It is still another object of the present invention to provide a method of making a filament wound strut with end fittings connected to the strut and which are effectively made integral into the strut in order to effectively react to both compressive and tension loads.

The present invention thereby provides a strut which can be used in a variety of load transmitting applications and which is formed of a filamentary material arranged in such manner that it is efficient in reacting to both tension and compressive loads and which is made with a minimal amount of labor involved such as, for example, filament winding.

With the above and other objects in view, my invention resides in the novel features of form, construction, arrangement and combination of parts and components presently described and pointed out in the claims.

### SUMMARY OF THE INVENTION

The present invention provides, in broad terms, a unique composite strut which is designed for efficiently reacting both tension and compressive loads and a method for producing that composite strut in such manner that load is transferred in both tension and compression and where the strut is designed to react both the tension and compression loads.

The strut of the invention is generally characterized by a hollow elongate composite formed body which will generally carry the compressive load. The body should preferably be of a cylindrical, square or rectangular cross-sectional shape. However, other geometric shapes are envisioned within the concept of the invention.

End fittings such as, for example, metal end fittings, may be adhesively bonded into the ends of the hollow body. End fittings, which are formed of materials other than metals, are also contemplated within the present invention.

One of the important aspects of the invention is that the end fittings, even if they are formed of a non-composite material, are essentially and effectively made integral with the body by use of a filament containing strap wrapped about both the end fittings ans the body. In this way, the end fittings are retained not only by the adhesive bonding, but by the filament strap as well. This unique strut design is highly effective in that it allows for carrying the compressive load into the hollow body and through the end fittings secured to that body. The compressive loads are actually carried into the body through shear forces applied to one or more end fittings and through the adhesive bonding of those fittings to the body. The tension loads are carried into the body by means of the continuous composite strap which is wrapped around the fittings and the body. The use of the strap in this way takes advantage of the structural efficiencies which are attainable using the composite materials.

By virtue of the above identified strut construction, there is an efficient load transfer in both tension and compression. Moreover, there are clearly defined load paths for both tension loads and compression loads. Further, this design also allows for low cost manufacturing along with the method of making the strut as hereinafter described.

The end fittings may adopt a variety of forms as, for example, lug shaped endings or forked endings or the like. Moreover, the end fittings may be formed of a metal, as aforesaid, including, for example, aluminum, steel, titanium and the like. The body may preferably be formed of a carbon-epoxy filament-resin combination.

The method of the invention relies upon the initial formation of the elongate body. Typically, the body may be formed of any effective composite material, such as carbon, and impregnated with a suitable resin matrix such as, for example, epoxy-resins or the like. Any conventional thermo-plastic or thermo-setting resin may be employed for this purpose. Even more preferably, the body may be formed in a conventional protrusion operation.

The body, in the preferred embodiment, is generally of a square shape or, otherwise, of a rectangular shape. The body could be formed with relatively sharp corners forming a true square or rectangular cross-section. Otherwise, to aid in local stability, the corner portions could be rounded in a manner as hereinafter described. The end fittings are preferably made in conventional metal forming operations and, typically, may be made of steel, aluminum or titanium, as aforesaid. The end fittings may be secured in the open ends of the body by a suitable epoxy as, for example, an epoxy-resin. Moreover, the end fittings may be provided with a key-lock stud.

After the end fittings are secured to the elongate body, a filament strap is wound about the end fittings and along the sides of the elongate body. Thus, a continuous strap is formed as, for example, by a filament winding operation. In this way, the end fittings are constrained by both the adhesive bonding and the filament wound strap.

In addition, and if desired, additional sheets of composite material may be placed on opposite sides or, for that matter, all four sides of the elongate body and prior to the actual winding of the filament strap.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of one form of strut which may be constructed in accordance with and embodying the present invention;

FIG. 2 is an exploded perspective view showing some of the main components of the strut of FIG. 1;

FIG. 3 is a vertical sectional view taken substantially along line 3-3 of FIG. 2;

FIG. 4 is a vertical sectional view, similar to FIG. 3, and showing a slightly modified form of strut in accordance with the present invention;

FIG. 5 is a fragmentary perspective view, partially in section, and showing still a further modified form of strut having a plurality of bands formed around the end fittings and the body;

FIG. 6 is a fragmentary perspective view, somewhat similar to FIG. 5, and showing a strut similar to that of FIG. 5 but with rounded corner edges to provide localized stability;

FIG. 7 is a vertical sectional view, somewhat similar to FIG. 4, and showing still a further modified form of strut in accordance with the present invention;

FIG. 8 is a fragmentary sectional view showing the mounting of an end fitting within an elongate body and with a threaded end fitting and with a forked end fitting secured thereto;

FIG. 9 is a fragmentary side-elevational view of an end portion of a body and end fitting secured thereto in accordance with the present invention;

FIG. 10 is a fragmentary horizontal sectional view showing the securement of an end fitting within the body of a strut;

FIG. 11 is a fragmentary perspective view showing the provision of a forked end fitting in a body in accordance with the present invention; and

FIG. 12 is a fragmentary sectional view taken substantially along the plane of line 12-12 of FIG. 11.

### DETAILED DESCRIPTION OF A PREFERRED EMBODIMENT

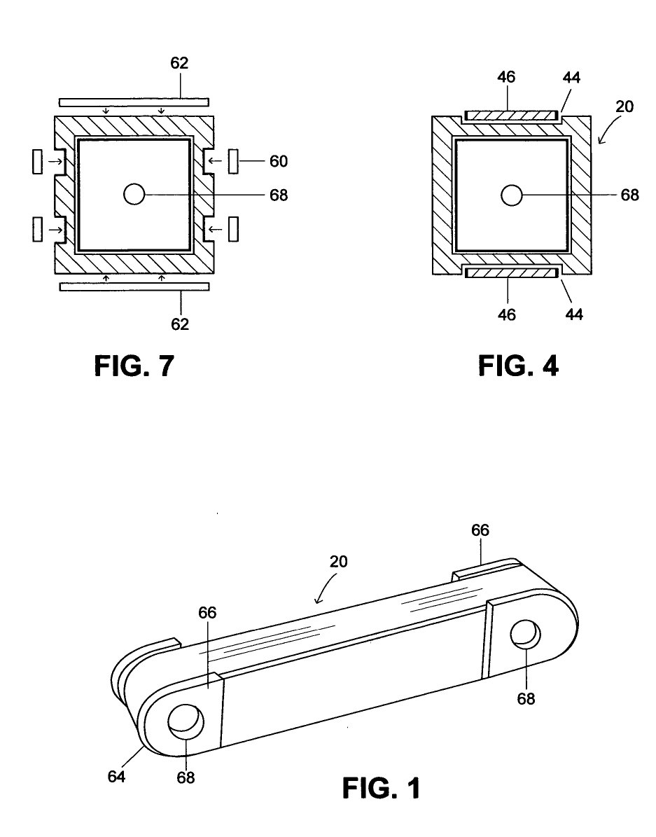

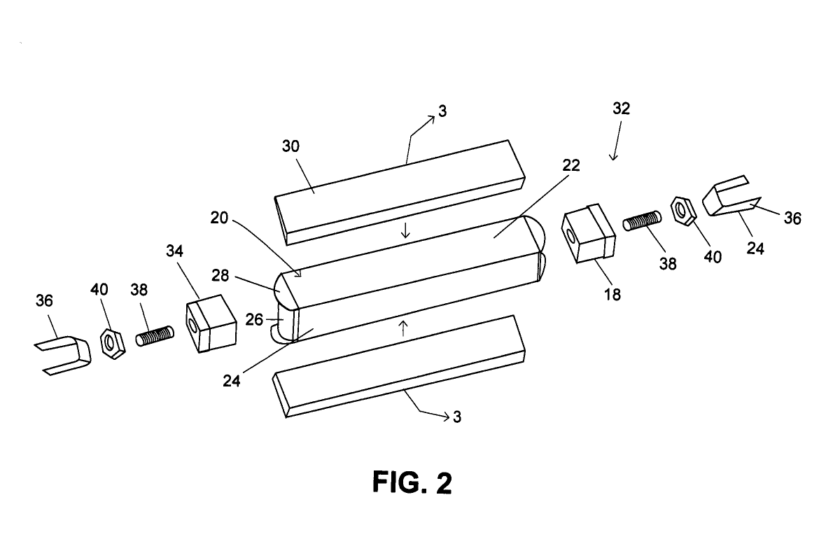

Referring now in more detail and by reference characters to the drawings which illustrate a preferred embodiment of the invention, 20 designates one form of strut produced in accordance with the present invention. FIG. 2 illustrates, more fully, the components forming part of the strut of FIG. 1.

The term “strut”, as used herein, is used in a broad sense to refer to any member which is capable of reacting one or more loads such as, for example, a tension load or otherwise a compression load. Other terms, such as shock absorbing units, tension tiebars, resistance assemblies and the like have been applied to members which react loads. All of these devices, regardless of the name, operate to react loads, as does a strut and, therefore, all such devices are embodied by the term “strut”.

The strut of the invention is formed with a tubular body 22 having a plurality of side walls 24 and a hollow interior 26. In the embodiment of the invention as shown in FIGS. 1, 2 and 3, it can be seen that the body of the strut is essentially square in cross-sectional shape. However, as indicated previously, any cross-sectional shape of the type previously described can be employed.

In the embodiment of the strut as shown, protruding flanges 28 are formed at the opposite ends of opposed surfaces of the strut as, for example, the upper and lower surfaces thereof. In addition, and if desired, overlays of fabric such as composite material fabric 30 may be applied to both of the opposite flat faces of the strut as, for example, the upper and lower faces. For that matter, overlays can be applied to all four surfaces thereof.

Provided for insertion into the opposite open ends of the elongate body 20 are a pair of fitting assemblies 32. In this case, each fitting assembly 32 comprises a fitting insert 34 which has the same cross-sectional shape as the open end of the tubular bore 26 of the body 20. Moreover, these fittings are sized to be snugly received in the open ends when inserted therein. The fitting retainers 34 are adhesively secured to the interior of each of the opposite ends of the tubular body 20.

The fitting assembly 32 also preferably comprises a fitting end, such as a forked end, 36 as shown and which is retained in the fitting retainer block 34 by means of bolts 38 and lock nuts 40. Any means for retaining the ends, such as a lug end, a fork end or the like, can be employed.

After the end fitting assemblies 32 have been adhesively secured within the opposite open ends of the body 22, filament containing strands can then be wound about opposite flat faces of the body and the fittings in continuous loops. Thus, in the case of the forked end fittings 36, filament strands would be wound about upper and lower flat faces of the body 20 and against the bight portion of the forked ends 36 in continuous loops. These filament containing strands would then capture the entire fitting assemblies within the open ends of the body 20.

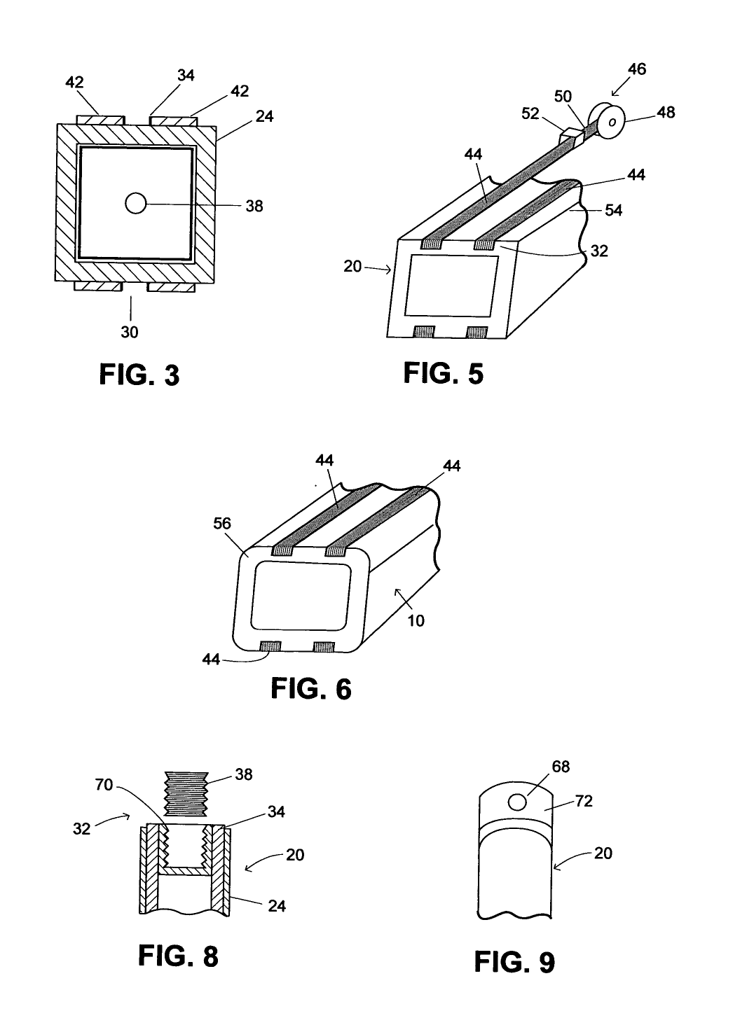

FIG. 3 illustrates a pair of spaced apart filament wound belts 42 which are wound about upper and lower flat faces of the body 20. In this respect, it should be recognized that either a single belt or a plurality of belts can be wound.

FIG. 4 illustrates an embodiment of the invention in which the body 20 is provided with an elongate groove or recess 44 on each of the opposite flat faces thereof to receive strands of filament material to form a continuous belt 46 thereof. In this case, the belt is shown as extending across upper and lower flat faces although it should be understood that the belt could extend around the side faces of the strut. In like manner, belts could be formed both on the upper and lower faces and on the pair of opposed side faces.

FIG. 5 illustrates an embodiment in which there are a pair of opposed grooves 44 on each of the upper and lower flat faces of the body 20. These grooves are shown as being rectangular in shape but they could be essentially formed of any shape. Moreover, FIG. 5 schematically illustrates the application of filament containing strands to form continuous belts around the upper and lower flat faces by means of a conventional filament winding apparatus 46. In this case, the filament winding apparatus is being schematically illustrated as containing a spool 48 paying out filament containing strands 50 which are applied through a feeding head 52 to the grooves 44.

FIG. 6 illustrates an embodiment, very similar to FIG. 5, except that in FIG. 5 the four walls forming the body meet at sharp corners 54. In the embodiment of the invention as shown in FIG. 6, the corners 56 are rounded so as to provide localized strength.

FIG. 7 illustrates an embodiment of the invention in which pairs of filament containing belts 60 are wound about opposite flat faces of the body. In addition, a fiber containing mat or fabric sheets 62 can be applied to the remaining flat faces of the body. Moreover, the entire assembly can then be filament wound as hereinafter described.

In the embodiment of the invention as illustrated in FIG. 1, forked end pieces 36 are not employed. Rather, the end pieces are in the form of lugs 64 having lug plates 66 and mounting holes 68 extending therethrough. However, any suitable end depending upon the type of connection for the strut may be employed. The end fittings which are shown herein are only exemplary of those which can be used.

FIGS. 8 and 9 more fully illustrate the attachment of the fitting assemblies 32 to the opposite ends of the body 20. In this case, lug fittings are shown in FIG. 9. Typically, the fittings comprise the retaining block 34 as shown and which is provided with an internally threaded bore or hole 70 which is designed to threadedly receive the bolt 38. In this way, any end, such as the end 36 or a lug end 72 as shown in FIG. 9, can be used.

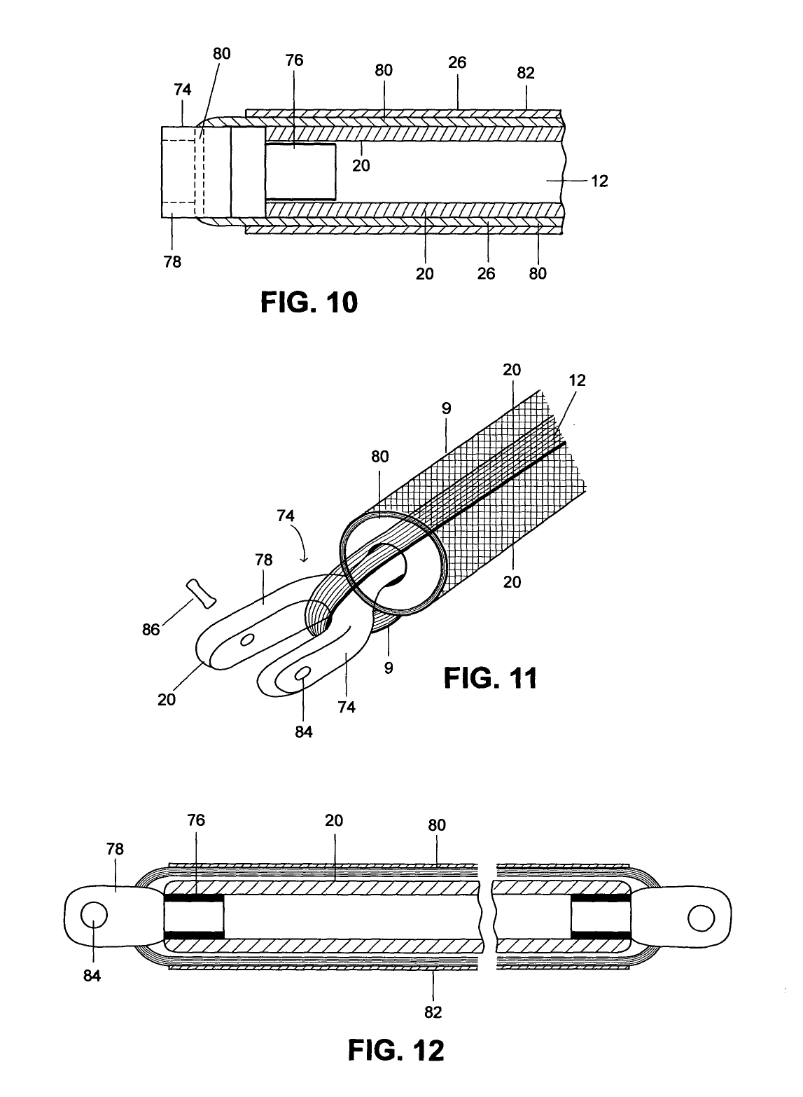

FIG. 10 more fully illustrates one mode of securing an end fitting to the interior bore of the body 20 and the completion of the formation of the strut. In this case, the fitting, such as, for example, a forked end fitting 74, has a reduced retainer block 76 inserted in and retained in the open end of the body 20, as best shown in FIG. 10. The forked end fitting is provided with a forked section 78 and flange 80 which abuts against the end of the body 20 as shown in FIG. 10 of the drawings. The retainer block 76 is adhesively secured within the body.

After the fitting assembly is secured within the end of the body, it is retained by means of belts comprised of filament containing strands 80.

After the belts 80 have been applied by filament winding, the entire strut can then be wound with one or more additional layers of filament containing reinforcing strands 82, also as best shown in the embodiment of FIG. 10. Any conventional filament winding apparatus, such as that apparatus schematically illustrated in FIG. 5 could be used for winding the additional filament strands.

In the embodiment of the invention as shown in FIG. 11, which includes the forked end fitting, this fitting can be conventionally provided with holes 84 which will receive a pin or locking bolt 86. In the embodiment as shown in FIG. 12, the entire locking assembly and the body are then suitably wound with one or more additional layers of filament containing strands, such as the strands 82.

As indicated previously, the various described embodiments of a strut are highly effective in that each allow for the carrying of a compressive load directly into the hollow body through the end fitting assemblies. As indicated, the end fitting assemblies are initially held by an adhesive bonding and are then captured by the additional bands or belts wrapped thereabout. This also allows for carrying the tension load through the belts or straps. The entire assembly utilized composite materials in order to achieve the advantage of structural efficiency and relatively light weight.

Thus, there has been illustrated and described a unique and novel Reinforced Tension and Compression Reacting Strut and Method of Making Same and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

1 A reinforced composite tension and compression reacting strut which is highly efficient in reacting both compressive and tension loads imposed on the strut as a result of connection to a load bearing structure, said strut comprising:
a) an elongate body formed primarily of a reinforced plastic composite material;
b) an end fitting adapted for securement to an end of said elongate body and which may also be adapted for securement to a structure; and
c) a strap extending along opposite surface of said body and also extending about a portion of the fitting at an end of said body and holding said fittings to said body to thereby reinforce the fitting against compressive and tension loads.

2 The reinforced composite tension and compression reacting strut of claim 1 further characterized in that said strut further comprises:
a pair of fittings with one of each of the opposite ends of said body and where the strap extends about both of said fittings and holds such fittings to the body.

3 The reinforced composite tension and compression reacting strut of claim 2 further characterized in that:
an adhesive also initially secures said fittings to said body.

4 The reinforced composite tension and compression reacting strut of claim 2 further characterized in that said strap is comprised of resin impregnated filament reinforcing composite material.

5 The reinforced composite tension and compression reacting strut of claim 1 further characterized in that said fitting has a recessed area allowing said strap to be retained therein.

6 The reinforced composite tension and compression reacting strut of claim 4 further characterized in that said body of said strut further comprises:
elongate grooves extending along said opposite surface to receive straps extending along the surface of said body.

7 The reinforced composite tension and compression reacting strut of claim 1 further characterized in that said body has a generally rectangular cross-sectional shape and edges of said body are rounded.

8 The reinforced composite tension and compression reacting strut of claim 7 further characterized in that said body has a hollow core.

9 The reinforced composite tension and compression reacting strut of claim 1 further characterized in that said strut comprises:
additional filament reinforcing material wound around about said end fitting and said body to make the end fitting integral with the body.

10 A reinforced composite tension and compression reacting strut which is highly efficient in reacting both compressive and tension loads imposed on the strut as a result of connection to a load bearing structure, said strut comprising:
a) a hollow elongate body formed primarily of a reinforced plastic composite material for carrying compressive load;
b) an end fitting adapted for securement to an end of said elongate body and which may also be adapted for securement to a structure;
c) securement means for holding said fitting at an open end of said body; and
d) a filament reinforced strap extending along opposite surfaces of said body to carry tensional loading and also holding said fittings to said body.

11 The reinforced composite tension and compression reacting strut of claim 10 further characterized in that said strut further comprises:
a pair of fittings with one of each of the opposite ends of said body and the strap extends to each of said fittings and aids in holding such fittings to the body.

12 The reinforced composite tension and compression reacting strut of claim 10 further characterized in that:
securement means comprises adhesive for also initially securing said fittings to said body.

13 The reinforced composite tension and compression reacting strut of claim 10 further characterized in that said fitting has a recessed area allowing said strap to be retained therein.

14 The reinforced composite tension and compression reacting strut of claim 10 further characterized in that said body has a generally rectangular cross-sectional shape and edges of said body are rounded.

15 The reinforced composite tension and compression reacting strut of claim 10 further characterized in that said strut comprises:
additional filament reinforcing material around about said end fitting and said body to make the end fitting integral with the body.

16 A method of making a reinforced composite tension and compression reacting strut which is highly efficient in reacting both compressive and tension loads imposed on the strut, said method of making the strut comprising:
a) forming an elongate hollow body primarily from a reinforced plastic composite material to carry compressive loads;
b) securing an end fitting adapted to an end of said elongate body; and
c) wrapping a strap along opposite surfaces of said body and also extending about a portion of the fitting at an end of said body and holding said fitting to said body to thereby reinforce the fitting in the end of the body.

17 The method of making the reinforced composite tension and compression reacting strut of claim 16 further characterized in that said method further comprises:
a) applying an adhesive to at least one of said fitting or body;
b) inserting a portion of said fitting into an open end of said body; and
c) allowing said adhesive to cure.

18 The method of making the reinforced composite tension and compression reacting strut of claim 16 further characterized in that said method comprises:
filament winding the reinforcing strap about said body and said fitting.

19 The method of making the reinforced composite tension and compression reacting strut of claim 16 further characterized in that said method comprises:
wrapping a reinforcing strap through a recessed area of said fitting to tightly hold said fitting to said body.

20 The method of making a reinforced composite tension and compression reacting strut of claim 16 wherein the method of making the strut comprises:
securing end fittings to each of the opposite ends of said elongate body; and
wrapping a strap along opposite surfaces of said body and also extending about a portion of each fitting.

21 The method of making the reinforced composite tension and compression reacting strut of claim 20 further characterized in that said method further comprises:
a) applying an adhesive to at least one of said fitting or body at each of the opposite ends;
b) inserting a portion of said fitting at each end into an open end of said body; and
c) allowing said adhesive to cure.

22 The method of making the reinforced composite tension and compression reacting strut of claim 20 further characterized in that said method comprises:
wrapping additional filament reinforcing material around about said end fitting and said body to make the end fitting integral with the body.
